(19) United States
(12) Patent Application Publication
(10) Pub. No.: US 2007/0099734 A1
(43) Pub. Date: May 3, 2007

(54) Bushingless variable speed separator drive

(76) Inventors: Roy David Hansen, Moline, IL (US); Stephen James Vanwynsberghe, Cambridge, IL (US); Daniel Ray Anderson, Bettendorf, IA (US)

Correspondence Address: DEERE & COMPANY, ONE JOHN DEERE PLACE, MOLINE, IL, 61265, US

(21) Appl. No.: 11/260,944

(22) Filed: Oct. 28, 2005

(51) Int. Cl. F16H 55/56

(52) U.S. Cl. 474/8

(57) ABSTRACT

A variable speed separator drive for an agricultural combine includes a hub formed of chrome plated steel, and a movable sheave half carried by the hub. The movable sheave half is formed from nodular cast iron and includes an inside diameter with at least one spiral lubricating groove.

### FIELD OF THE INVENTION

The present invention relates to agricultural combines, and, more particularly, to variable speed belt drives for driving a separator in such combines.

### BACKGROUND OF THE INVENTION

An agricultural combine includes a head and a feeder housing which remove the crop material from the field, gather the crop material and transport the crop material to a separator. The separator removes the grain crop material from the non-grain crop material. The grain is transported to a grain tank, and the non-grain crop material is discharged to the field. The separator typically includes a rotary element which is belt driven. The belt drive is in the form of a variable speed belt drive having a spring loaded movable sheave half which can move in an axial direction on the outside diameter of the hub. A relatively large clearance space is provided between the movable sheave half and the hub which accommodates polymer bushings therebetween. The relatively large clearance space along with the somewhat elastomeric properties of the polymer bushings allow the movable sheave half to wobble during use, which may shorten belt life.

What is needed in the art is a variable speed belt drive for a separator in an agricultural combine which has decreased wear between the movable sheave half and hub, and increased belt life.

### SUMMARY OF THE INVENTION

The present invention provides a variable speed separator drive which eliminates bushings between the hub and movable sheave half by forming the hub from hardened chrome plated steel and forming the movable sheave half from nodular cast iron with a spiral lubricating groove at the inside diameter.

The invention comprises, in one form thereof, a variable speed separator drive for an agricultural combine, including a hub formed of chrome plated steel, and a movable sheave half carried by the hub. The movable sheave half is formed from nodular cast iron and includes an inside diameter with at least one spiral lubricating groove.

### BRIEF DESCRIPTION OF THE DRAWINGS

FIG. 1 is a perspective view of an embodiment of a variable speed separator drive of the present invention;

FIG. 2 is a cross-sectional view through the variable speed separator drive taken along line 2-2 in FIG. 1; and

FIG. 3 is a fragmentary, perspective view of the movable sheave half shown in FIG. 2.

### DESCRIPTION OF THE PREFERRED EMBODIMENT

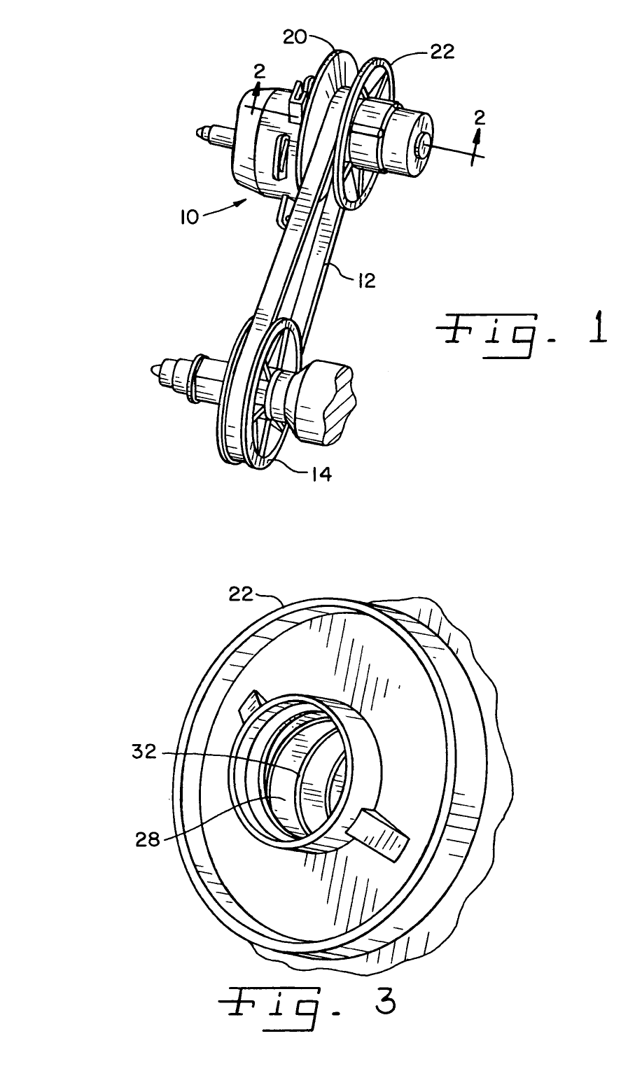

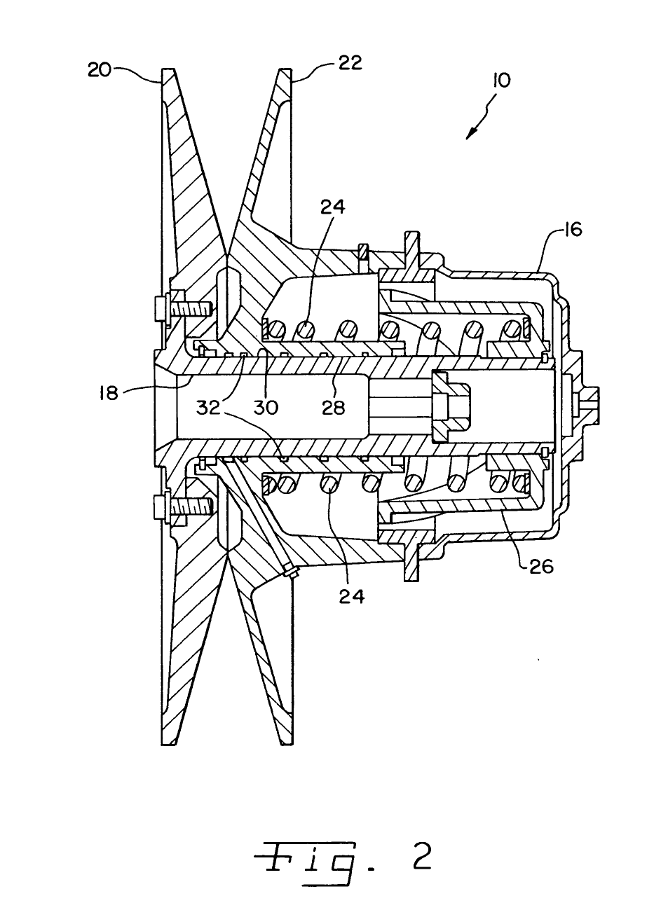

Referring now to the drawings, and more particularly to FIG. 1, there is shown an embodiment of a variable speed belt drive 10 of the present invention which receives input power from a belt 12 driven by a drive pulley 14. In the embodiment shown, variable speed belt drive 10 is in the form of a variable speed separator drive for rotatably driving a separator in an agricultural combine. Drive pulley 14 may thus be driven, e.g., by a transmission coupled to an internal combustion (IC) engine.

Variable speed belt drive 10 generally includes a housing 16, hub 18, fixed sheave half 20 and movable sheave half 22. Fixed sheave half 20 is coupled with an end of hub 18, and is positioned in opposition to movable sheave half 22. Fixed sheave half 20 may be formed from any suitable material, such as steel.

Hub 18 is formed from hardened and chrome plated steel. The chrome plating provides a highly finished surface for carrying movable sheave half 22.

Movable sheave half 22 is carried by hub 18 and is movable in an axial direction along hub 18. Movable sheave half 22 is biased toward fixed sheave half 20 using a spring 24. An opposed base 26 is keyed to and carried by hub 18, and provides an opposed fixed surface against which spring 24 acts to bias movable sheave half 22 toward fixed sheave half 20.

Housing 16 is coupled to and moves with movable sheave half 22. Housing 16 encloses hub 18, spring 24 and cam 26.

Movable sheave half 22 is carried by and slidably movable relative to hub 18. Movable sheave half 22 includes an inside diameter 28 which defines a clearance distance relative to outside diameter 30 of hub 18 which is smaller than the clearance distance in conventional variable speed belt drives using bushings between the hub and movable sheave half. More particularly, movable sheave half 22 has an inside diameter 28 which is approximately between 0.01 to 0.04 millimeters less than outside diameter 30 of hub 18. In the embodiment shown, the clearance distance is approximately 0.01 millimeters between inside diameter 28 and outside diameter 30. A smaller clearance distance between hub 18 and movable sheave half 22 results in less oscillation of movable sheave half 22, which in turn significantly improves the operating life of belt 12 carried by variable speed belt drive 10.

Movable sheave half 22 is formed from cast iron, preferably nodular cast iron having interspersed graphite nodules. The graphite nodules which are exposed at inside diameter 28 of movable sheave half 22 provide reduced wear during operation.

Movable sheave half 22 also includes one or more lubricating grooves 32 formed in inside diameter 28. In the embodiment shown, movable sheave half 22 includes a continuous spiral lubricating groove formed in inside diameter 28. Lubricating groove 32 is configured with a shape and size to ensure proper lubrication between movable sheave half 22 and hub 18, and may vary depending upon the application or lubricant (e.g., grease or oil).

During use, the torque which is applied to the output shaft of variable speed belt drive 10 (extending from the center of hub 18) controls the axial movement of movable sheave half 22, and thus in turn the spacing between movable sheave half 22 and fixed sheave half 20. The reduced clearance distance between inside diameter 28 of movable sheave half 22 and outside diameter 30 of hub 18 reduces wobble of movable sheave half 22 and improves belt life. The nodular graphite and grease grooves at inside diameter 28 of movable sheave half 22, and the chrome plated outside diameter 30 of hub 18, provide reduced friction and wear between movable sheave half 22 and hub 18.

Having described the preferred embodiment, it will become apparent that various modifications can be made without departing from the scope of the invention as defined in the accompanying claims.

1. A variable speed belt drive, comprising:
a hub comprised of steel; and
a movable sheave half carried by said hub, said movable sheave half including an inside diameter with at least one lubricating groove.

2. The variable speed belt drive of claim 1, wherein said at least one lubricating groove comprises a continuous spiral groove.

3. The variable speed belt drive of claim 1, wherein said movable sheave half is comprised of cast iron.

4. The variable speed belt drive of claim 3, wherein said movable sheave half is comprised of nodular iron.

5. The variable speed belt drive of claim 4, wherein said nodular iron includes graphite nodules at said inside diameter.

6. The variable speed belt drive of claim 1, wherein said hub comprises a chrome plated steel hub.

7. The variable speed belt drive of claim 6, wherein said hub comprises a hardened chrome plated steel hub.

8. The variable speed belt drive of claim 1, wherein said hub has an outside diameter which is approximately between 0.01 to 0.04 mm less than said inside diameter of said movable sheave half.

9. The variable speed belt drive of claim 8, wherein said hub has an outside diameter which is approximately 0.01 mm less than said inside diameter of said movable sheave half.

10. The variable speed belt drive of claim 1, including a fixed sheave half carried by said hub in opposition to said movable sheave half.

11. The variable speed belt drive of claim 10, wherein said fixed sheave half is coupled with an end of said hub.

12. The variable speed belt drive of claim 1, wherein said variable speed belt drive has a torque output which corresponds to a clamping force on a belt carried thereby.

13. The variable speed belt drive of claim 12, wherein said movable sheave half is spring loaded.

14. The variable speed belt drive of claim 1, wherein said variable speed belt drive comprises a separator drive for an agricultural combine.

15. A variable speed separator drive for an agricultural combine, comprising:
a hub comprised of chrome plated steel;
a movable sheave half carried by said hub, said movable sheave half being comprised of nodular cast iron and including an inside diameter with at least one spiral lubricating groove.

16. The variable speed separator drive of claim 15, wherein said at least one lubricating groove comprises a continuous spiral groove.

17. The variable speed separator drive of claim 15, wherein said nodular cast iron includes graphite nodules at said inside diameter.

18. The variable speed separator drive of claim 15, wherein said hub comprises a hardened chrome plated steel hub.

19. The variable speed separator drive of claim 15, wherein said hub has an outside diameter which is approximately between 0.01 to 0.04 mm less than said inside diameter of said movable sheave half.

20. The variable speed separator drive of claim 19, wherein said hub has an outside diameter which is approximately 0.01 mm less than said inside diameter of said movable sheave half.

21. The variable speed separator drive of claim 15, including a fixed sheave half carried by said hub in opposition to said movable sheave half.
